(19) United States
(12) Patent Application Publication
(10) Pub. No.: US 2012/0043682 A1
(43) Pub. Date: Feb. 23, 2012

(54) PROCESS FOR PRODUCING A MATERIAL SIMILAR TO LEATHER

(75) Inventor: Michele RUFFIN, Montagnana (PD) (IT)

(73) Assignee: OKINAWA S.r.L., Montagnana (PD) (IT)

(21) Appl. No.: 13/212,638

(22) Filed: Aug. 18, 2011

(30) Foreign Application Priority Data
Aug. 20, 2010 (IT) PD2010A000260

(51) Int. Cl. B29C 41/32

(52) U.S. Cl. 264/78; 264/165

(57) ABSTRACT

Process for producing a material similar to leather, which foresees:
a step of providing a base material (1) in band form and comprising a cellulose fibre impregnated with a copolymer dispersion;
a step of impregnating the base material (1) in band form with at least one liquid product;
a step of compressing the base material (1) in band form in a duct (2), wherein the base material (1) in band form is compressed transversally in the direction of its own width sliding in a compression portion of the duct (2) having a smaller width than the width of the base material (1);
a step of spreading out the base material (1) in band form, wherein the latter opens out at least partially along its own width outside of the compression portion of the duct (2);
   Moreover, the process in object foresees that the compression step and the spreading out step are repeated cyclically.

### FIELD OF APPLICATION

The present invention concerns a process for producing a material similar to leather, according to the preamble of the independent claim

The process concerned fits into the field of the production of thin materials, such as the fabrics able to be used in the field of clothing, furnishing, etc., and it is therefore intended to be advantageously used to make products looking like leather such as clothing, footwear, labels, tags, bags, coatings, cases, etc.

### STATE OF THE ART

As known, there is an ever increasing need, particularly in the field of the production of fabrics and materials for clothing, to produce synthetic or natural materials that are very similar in appearance and strength to natural leather, in the technical jargon known by the term imitation leather or leatherette.

In particular, there are known processes for producing imitation leather that foresee treating a base support of cellulose fibre with aqueous solutions in accordance with techniques known in the field of paper production.

For example, U.S. Pat. No. 4,212,927 describes a process for producing imitation leather, which foresees subjecting a base support of cellulose fibre to a succession of baths containing dispersions or aqueous suspensions of macromolecular substances, in accordance with known techniques for producing paper. In greater detail, such a process foresees the following operative steps:
a step of introducing the base support in an aqueous dispersion containing binding agents;
a step of impregnating said base material with an aqueous dispersion containing an acrylic polymer;
a step of making an intermediate layer on the base material, which foresees coating the base support with a bath containing a suspension of a vinylic copolymer and subsequently drying the support thus treated;
a step of making a surface finishing layer on the intermediate layer, which foresees coating the intermediate layer with a bath containing a suspension of acrylic copolymers and coalescence agents, like for example ethers of ethyleneglycol, and then drying the material thus obtained;
a step of printing the finishing layer with one or more colours;
a step of processing the finishing layer, which foresees subjecting the latter to mechanical processing, like for example calendering, embossing, scuffing, to produce a visual effect similar to that of the grain of natural leather on the finishing layer.

In practical use, the imitation leather obtained with the process briefly described above has proven not to be without drawbacks.

The main drawback of such imitation leather is due to the poor strength of the finishing layer, which easily degrades and detaches from the underlying intermediate layer with a consequent loss of the aesthetic characteristics of imitation leather. Moreover, such a drawback makes the imitation leather obtained with the process described above unsuitable for being subjected to washing processes commonly foreseen for items of clothing, since the surface finishing layer undergoes obvious alterations if washed with detergents, or in a washing machine, or even if washed in a dyehouse, for example using ethylene perchloride.

In order to avoid such drawbacks processes for producing imitation leather have been placed on the market that foresee subjecting sheets of synthetic material to treatments used in the field of leather tanning, to make the appearance of such synthetic materials similar to that of natural leather.

For example, patent IT 1178956 describes a process for producing imitation leather that foresees subjecting a sheet of synthetic material to a drum tanning treatment, said sheet of synthetic material comprising a vacuolated polyurethane support and a coating film made from polyurethane resin and printed with a pattern similar to natural leather.

In greater detail, such a process foresees the following operating steps:
a step of loading the drum with the sheet of synthetic material tightly bound so as to form a bundle of dimensions such as to be able to be introduced into the drum;
a wetting step that foresees treating the sheet in the rotary drum with water with added surfactants;
a subsequent step of treating the sheet with a saline solution of bivalent and trivalent metal salts;
a step of raising the pH of the saline solution through the insertion into the rotary drum of caustic soda to make part of the salts contained in the saline solution precipitate in the form of gel;
a surface washing step of the sheet to eliminate the gel from the surface of the sheet itself;
a step of treating the sheet of synthetic material with an aqueous solution of aldehyde or polyaldehyde to increase the flexibility and mechanical strength of the sheet itself;
a stuffing treatment step of the sheet of synthetic material, which foresees inserting fatty substances, for example mineral oils or esters of fatty acids, into the rotary drum.

Thereafter, the material can be subjected to further treatments in the drum, like for example dyeing, cold washing, fireproofing and softening.

Finally, there is a step of extracting the sheet of synthetic material from the drum and a step of drying the sheet with hot air.

This last process for producing imitation leather has in practice also proven not to be without drawbacks.

A first drawback is linked to the fact that the process described in IT 1178956 foresees using a sheet of synthetic material, which does not make it possible to obtain an imitation leather with the characteristics of breathability and consistency of natural leather.

A further drawback is linked to the fact that the process for producing imitation leather described in IT 1178956 needs to use synthetic material cut into sheets of relatively short length (maximum of 10 metres) to allow it to be loaded in the drum. This greatly limits the amount of imitation leather that can be produced through such a process with consequent long production times.

A further drawback is linked to the fact that the process for producing imitation leather described in IT 1178956 foresees carrying out many treatment steps of the sheet of synthetic material with chemical products, consequently resulting in long production times and high production costs.

Japanese patent JP 63303185 describes a process for producing a material similar to leather, which foresees subjecting a band of synthetic material to mechanical processing through counter-rotating rollers.

In greater detail, the process described in JP 63303185 foresees continuously unrolling the band of synthetic material from a support roller to subject it in succession to the following operative steps:
a step of dipping the band of synthetic material in a hot water bath at about 70° C., to make the band of synthetic material more flexible;
a step of drying the band of synthetic material inside a ventilation device suitable for blowing a hot airflow on the band itself;
a step of creasing the band of synthetic material by mechanical processing through pairs of counter-rotating rollers, in order to create a plurality of wrinkles on the band itself. In particular, such a creasing step foresees passing the band of synthetic material between many pairs of rollers arranged one after the other, and able to be actuated to move repeatedly one against the other to squash the band of synthetic material between them, causing the formation of wrinkles on it.

The main drawback of the known process described in JP 63303185 is due to the fact that, during the creasing step, the band of synthetic material can easily tear following squashing thereof between the pairs of counter-rotating rollers, with consequent poor quality of the product obtained.

Moreover, the wrinkling of the material similar to leather obtained through such a known process has proven not to be sufficiently long-lasting, in particular in the case in which the material is subjected to washing processes normally foreseen for items of clothing.

Moreover, carrying out the process described in JP 63303185 requires the use of an apparatus that is constructively complex and expensive to make, with a consequent worsening of the production costs of the material similar to leather.

Patent GB 1197564 describes a process for producing a material similar to leather, which foresees surface-depositing a layer of thermoplastic material, on which the wrinkling is made through mechanical processing, onto a sheeted base support.

In greater detail, such a process foresees the following operative steps:
a step of depositing the layer of thermoplastic material, for example polyurethane, on the surface of the base support;
a step of coating the layer of thermoplastic material with a protective film of plastic material, suitable for protecting the underlying layer of thermoplastic material during a subsequent creasing step;
a creasing step of the multi-layer material thus obtained in order to form a plurality of creases on it that give the product an appearance similar to leather. In greater detail, the creasing step is obtained through shaking the multi-layer material inside a rotary drum in dry conditions and without the addition of water.

However, the material similar to leather obtained with the process described in patent GB 1197564 has the drawback of easily being ruined.

In greater detail, the base support is not internally impregnated in its fibres with a polymer, but is surface-coated with the layer of thermoplastic material that consequently can easily detach from the base support. The creasing step itself is carried out dry without water, in order to avoid the detachment of the layer of thermoplastic material from the base support.

A further drawback is the fact that the creasing step of the multi-layer material takes place dry without water and thus without impregnating the fibres of the base support. This means that the creasing takes place by simple forming of creases and not by internal modification of the arrangement of the fibres.

Moreover, the process described in GB 1197564 needs the layer of thermoplastic material to be coated with a protective film to prevent the layer of thermoplastic material itself from being ruined during the creasing step, with consequent high production costs of the material similar to leather.

Patent EP 1941094 also discloses a process for producing a material similar to leather that foresees using a cellulose fibre impregnated with a copolymer dispersion as base material. In accordance with the process described in the patent, the creasing of the aforementioned material suitable for giving the latter the appearance of leather is obtained through the shaking of the material in the drums.

Such creasing thus obtained has proven not to be sufficiently long-lasting, and also requires treatments in the drum for very long time periods that have a negative impact upon the costs of the production process.

### DISCLOSURE OF THE INVENTION

In this situation, the main purpose of the present invention is therefore to eliminate the drawbacks of the prior art quoted above, by providing a process for producing a material similar to leather, which makes it possible to produce a material similar to leather with characteristics of appearance, breathability and consistency that are very close to those of natural leather.

A further purpose of the present finding is to provide a process for producing a material similar to leather that is suitable for obtaining the creasing of the material effectively and in short time periods.

A further purpose of the present finding is to provide a process for producing a material similar to leather, which makes it possible to produce a material similar to leather with long-lasting creasing.

A further purpose of the present finding is to provide a process for producing a material similar to leather that is simple and cost-effective to make.

A further purpose of the present finding is to provide a process for producing a material similar to leather that makes it possible to make large amounts of such a material in short production times.

These and yet other purposes are all accomplished by the process according to the attached claims

### BRIEF DESCRIPTION OF THE DRAWINGS

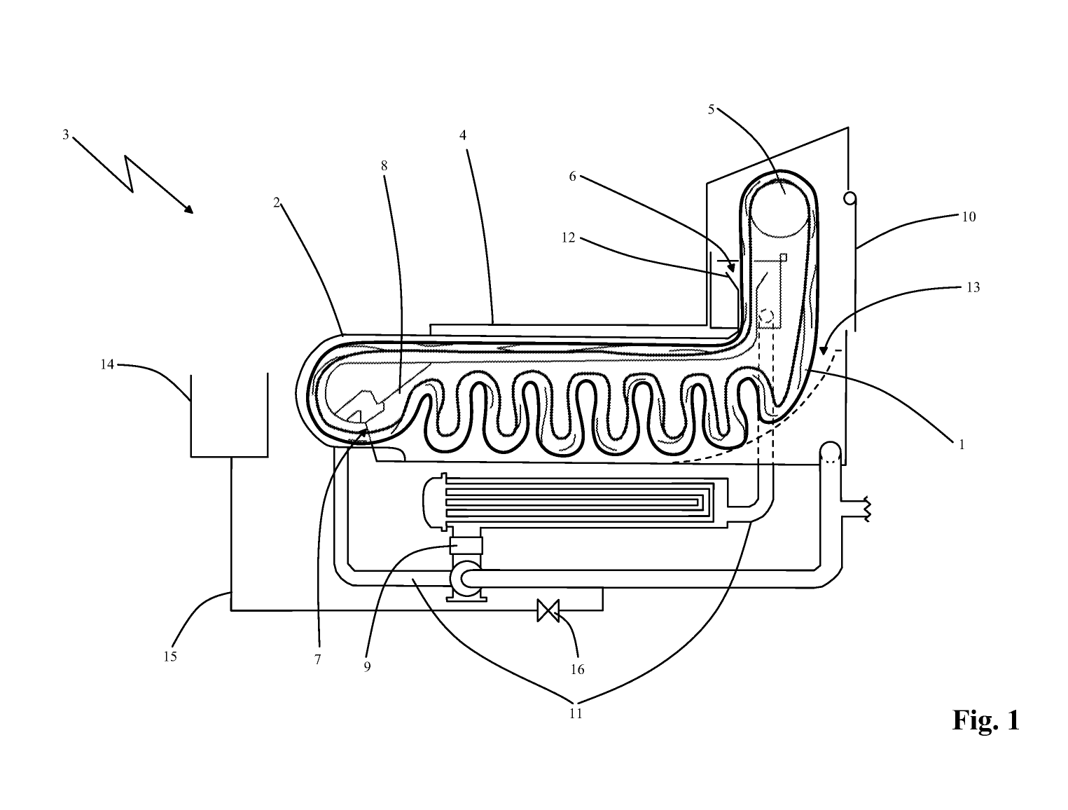

The technical characteristics of the present finding, according to the aforementioned purposes, can be clearly seen from the content of the claims given below and the advantages thereof will become clearer in the following detailed description, made with reference to the attached drawings, of an embodiment given purely as an example and not for limiting purposes, in which FIG. 1 represents a side section view of an apparatus for carrying out the process for producing a material similar to leather object of the present invention.

### DETAILED DESCRIPTION OF A PREFERRED EMBODIMENT

The process for producing a material similar to leather object of the present invention makes it possible to make a material with characteristics of appearance and consistency totally similar to those of natural leather. Such a material similar to leather is intended to be used, in particular, in the field of clothing to make clothes, footwear, labels, tags, bags, etc., and in the field of furnishing to make coatings, finishings, etc.

The process in object foresees using, as base material, a cellulose fibre impregnated with a copolymer, in particular styrene-butadiene, and preferably containing vulcanizing and aging agents and non-azo dyeing pigments.

According to the present invention, the process in object foresees a step of providing the base material 1 in band form, for example having a width equal to about 1.50 m and a length preferably between 50 and 200 m. The thickness of the base material 1 in band form is for example between 0.4 and 0.8 mm and it is selected as a function of the end use for which the material similar to leather obtained with the present process is intended.

Such a process, after the aforementioned provision step, foresees the following operative steps:
a step of impregnating the base material 1 in band form with at least one liquid product to make such a base material 1 more malleable;
a step of compressing the base material 1 in band form inside a duct 2, in which the base material 1 is compressed transversally in the direction of its own width sliding longitudinally inside at least one compression portion of such a duct 2 having a smaller width than the width of the base material 1 itself, in order to create a plurality of wrinkles on it;
a step of spreading out the base material 1 in band form, in which the latter opens out at least partially along its own width outside of the aforementioned compression portion of the duct 2 in which the compression step occurs.

The compression step and the spreading out step indicated above are repeated cyclically. In greater detail, the partial unwinding of the base material 1 foreseen during each spreading out step ensures that, in the subsequent compression step, the base material 1 is squashed by the walls of the duct 2 in a different position from that which it had taken up in the previous compression step, so that wrinkles form on it in different positions from those taken up previously.

This makes it possible to generate a creasing effect on the base material 1, which gives such a material an appearance totally similar to that of real leather.

Advantageously, the impregnation step of the base material 1 in band form foresees dipping it, before the compression step, in a liquid soaking product contained in a first tank (not illustrated) in order to make the base material 1 more malleable, in particular to facilitate its entry and passage in the duct 2 during the compression step.

In greater detail, the base material 1 in band form is dipped for at least half an hour in the first tank with the liquid soaking product brought to a temperature substantially between 40° C. and 80° C., for example about 50° C.

Preferably, the liquid soaking product comprises water added to with one or more soaking agents or surfactants, which reduce the surface tension of water to promote the penetration between the fibres of the base material 1.

The base material 1 is then removed from the first tank, wrung and possibly placed in storage wet before carrying out the compression and spreading out steps.

According to the present invention, the impregnation step foresees, preferably after the impregnation of the base material 1 with the liquid soaking product, impregnating the base material 1 in band form with a liquid treatment product, which flows inside the duct 2 during the compression step of the base material 1 itself.

Advantageously, in the impregnation step the aforementioned liquid treatment product, deep-soaking the base material 1, gives greater freedom of movement to the cellulose fibres, impregnated with the copolymer, of the base material 1. This, during the compression step, promotes the formation of wrinkles, which, thanks to the presence of the copolymer that impregnates the cellulose fibres, are stably fixed on the base material 1 through permanent deformation of the copolymer itself.

In greater detail, during the compression step the cellulose fibres of the base material 1 take up wrinkles that, being obtained with the base material 1 in impregnated form in the liquid treatment product, involve a modified distribution of the fibres themselves inside the base material 1 in accordance with the form of the wrinkles themselves. Such a modified distribution of the fibres is maintained in a subsequent drying step (described in detail hereafter), and has proven surprisingly stable over time.

Therefore, the impregnation of the base material 1 with the liquid treatment product advantageously promotes the permanent setting of the wrinkles formed during the compression step, ensuring the wrinkling thus obtained lasts a long time.

Preferably, the base material 1 is soaked with the liquid treatment product both during the compression step and during the spreading out step, in order to keep the base material 1 malleable, in particular making it possible to carry out the creasing of the base material 1 itself without it tearing or pulling away.

Advantageously, the impregnation of the base material 1 with the liquid treatment product during the compression and spreading out steps makes it possible to dye the base material 1, as will be described in detail hereafter.

In accordance with a particular embodiment of the present finding, the compression and spreading out steps of the base material are carried out in a rope dyeing apparatus 3 of fabrics.

In accordance with the example embodiment illustrated in FIG. 1, such an apparatus 3 comprises a containment body 4 inside which a rotary reel 5 is mounted to support the base material 1. The apparatus 3 also comprises the aforementioned duct 2, in which the compression step takes place, which is connected with the inside of the containment body 4. In greater detail, the duct 2 is equipped with a first opening 6, positioned under the rotary reel 5 and from which the base material 1 enters, and with a second opening 7, through which the duct 2 is connected to a second tank 8 formed inside the containment body 4 of the apparatus 3.

Moreover, the apparatus 3 comprises supply means, like for example a pump 9, to make the liquid treatment product circulate through the duct 2 and through the second tank 8.

In accordance with a particular solution of the present finding, the process in object foresees, preferably after the step of impregnation with the liquid soaking product in the first tank, a step of loading the base material 1 in band form in the apparatus 3.

In greater detail, such a loading step foresees inserting a first end of the base material 1 in band form in the containment body 4 of the apparatus 3, for example through the opening of an inlet door 10, and resting the base material 1 on top of the rotary reel 5. Thereafter, the base material 1 is made to pass through the duct 2 and through the second tank 8, until a second end of the base material 1 enters into the apparatus 3 from the inlet door 10. Thereafter, the first end of the base material 1 is sewn to the second end, closing the base material 1 in a loop; then the inlet door 10 of the apparatus 3 is closed.

Then there is a step of filling the second tank 8 with the liquid treatment product, in which the latter is conveyed, through the actuation of the pump 9, into the second tank 8 until the liquid treatment product reaches a predetermined fill level dependent on the length and thickness of the base material 1 in band form.

After the loading step, there is the step of impregnating the base material 1 with the liquid treatment product, in which the latter is conveyed by the pump 9 of the apparatus 3 inside the duct 2 through the first opening 6 of the latter to soak the base material 1. The liquid treatment product passes through the duct 2 and enters through the second opening 7 thereof into the second tank 8. The pump 9 then conveys the liquid treatment product back to the first opening 6 of the duct 2 through a recirculation circuit 11 of the apparatus 3.

After the loading step, it is foreseen to cyclically carry out the compression and spreading out steps, in which the base material 1 in band form closed in a loop is moved to continuously slide through the duct 2, carrying out the compression step, and through the second tank 8, carrying out the spreading out step. From the second tank 8 the base material 1 goes back to the duct 2 to repeat the compression and spreading out steps.

In accordance with a preferred embodiment of the process object of the present invention, the base material 1 is moved by the flow of liquid treatment product that flows through the duct 2 and the second tank 8. Otherwise, the base material 1 is also moved by the rotary reel 5, set in rotation for example by a motor (not illustrated).

In greater detail, the compression step of the base material 1 is carried out from the entry of the latter into the duct 2 through its first opening 6. Preferably, the duct 2 is equipped, at its first opening 6, with a funnel portion 12 to promote the conveying and compression of the base material 1 when it enters into the duct 2 itself.

The duct 2, as stated earlier, for at least its compression portion, has a width that is smaller than the width of the base material 1 so as to be able to compress the latter transversally. In accordance with the particular embodiment illustrated in FIG. 1, the entire duct 2 has a shorter width than that of the base material 1.

In particular, the width of the duct 2 is substantially between 1/20 and ⅕ of the width of the base material 1, preferably about 1/12. For example, with the base material 1 having a width equal to about 1.5 m and a thickness equal to about 0.4 mm, the duct 2 used has a width of about 12 cm.

During the compression step the walls of the duct 2 transversally compress the base material 1 that runs through it, said material therefore being stretched out in the form of rope. In this way the base material 1 transversally pinches itself, forming the aforementioned plurality of wrinkles.

The spreading out step foresees that the base material 1, which has come out from the duct 2, partially unwinds according to its width, until it takes up for example the width of about half a metre.

Advantageously, the spreading out step foresees introducing the base material 1 in band form, through the second opening 7 of the duct 2, into the second tank 8 containing the liquid treatment product, which has a greater width than the width of the duct 2. For example, the second tank 8 has a width of about 1 metre.

Preferably, the spreading out step foresees that the base material 1 runs dipped in the liquid treatment product contained in the second tank 8 until it comes out from an upper opening 13 of the second tank 8 itself. Through such an upper opening 13 the base material 1 goes back to the rotary reel 5 and goes back into the duct 2 to be subjected to a further compression step.

Advantageously, when the base material 1 goes back into the duct 2, it is compressed in a different position with respect to the one taken up in the previous compression steps, therefore forming wrinkles arranged in a different manner. Moreover, the different positioning of the base material 1 inside the duct 2 ensures that the wrinkles form at each compression with equal probability both on one face and on the other face of the base material 1.

Therefore, the cyclical carrying out of the compression and spreading out steps makes it possible to generate wrinkles on the base material 1 that are arranged completely at random, creating a surface creasing totally similar to that of natural leather.

Moreover, the use of the aforementioned operative steps of the base material consisting of cellulose fibres impregnated with a copolymer makes it possible to produce a material similar to leather with the same characteristics of breathability and consistency as natural leather.

In accordance with a different embodiment not illustrated in the attached FIG. 1, the step of spreading out the base material foresees passing the latter inside a second tank obtained simply through at least one widened portion of the duct having a greater width than that of the compression portion of the duct itself.

Advantageously, the liquid treatment product, used during the compression and spreading out steps, is brought to a temperature substantially between 40° C. and 120° C., in order to facilitate the fixing on the base material 1 of the wrinkles formed during the compression step. In particular, the fixing of the wrinkles is promoted by the dipping of the base material 1 in the bath of liquid treatment product contained in the second tank 8 and brought to a temperature of between 60° C. and 100° C.

Advantageously, the process for producing a material similar to leather object of the present invention foresees a step of dyeing the base material 1 with at least one dye dissolved in the liquid treatment product that circulates in the duct 2 and in the second tank 8.

In greater detail, the liquid treatment product is obtained with a solution comprising water and a mixture of dyes (for example of the metal complex type) dissolved in water and preferably one or more auxiliary products, for example cationic or anionic, to improve the uniformity and the solidity of the dye. The mixture of dyes is placed in a reservoir 14 outside of the apparatus 3 and is added to the liquid treatment product through an entry duct 15 able to be connected to the recirculation circuit 11 of the apparatus 3 for example through the opening of a valve 16.

In particular, the dyeing step is carried out at the same time as both the compression step and as the extension step, since during such steps the base material 1 is impregnated with the liquid treatment product that flows through the duct 2 and through the second tank 8, allowing the dyes dissolved in the liquid treatment product to fix to the fibres of the base material 1.

Otherwise, the process object of the present invention foresees producing a material similar to leather without dyeing the base material 1. In this last case the liquid treatment product, used in the impregnation, compression and spreading out steps, contains water preferably added to with soaking products.

Advantageously, the compression and spreading out steps of the present process for producing a material similar to leather are carried out cyclically for a time period lasting substantially at least one hour.

Such a minimum time period of about one hour is foreseen, for example, in the case in which the process does not comprise the dyeing step of the base material 1.

On the other hand, in the case in which the process in object also foresees the dyeing step, the compression and spreading out steps of the base material are carried out cyclically for a time period substantially between 2 and 8 hours, according to the type of dyes used and the thickness of the base material 1.

In greater detail, the time period in which the compression and spreading out steps are carried out cyclically comprises a first initial time period in which the temperature of the liquid treatment product is brought to about 40-50° C., a subsequent second period in which the temperature of the liquid treatment product is brought to about 80-100° C., and a third period in which the temperature of the liquid treatment product is brought to about 50-60° C.

The process in object for making a material similar to leather foresees, preferably after the dyeing step, one or more washing steps of the base material 1, in which the liquid treatment product is evacuated from the second tank 8, and the base material 1 is rinsed with water at room temperature in order in particular to remove the dyes not perfectly fixed to the fibres of the base material 1 itself.

After the compression and spreading out steps have been carried out cyclically, there is a step of loading the base material 1 from the apparatus 3, in which the two ends of the base material 1 are unsewn, and the latter is then removed from the containment body 4 of the apparatus 3.

Advantageously, the process for producing a material similar to leather object of the present invention foresees, after the compression and spreading out steps have been carried out cyclically, a step of drying the base material 1 in band form by blowing at least one airflow against the base material 1 itself.

Preferably, the airflow is heated to a temperature for example substantially between 80° C. and 160° C., in particular between 100° C. and 140° C.

In greater detail, the drying step foresees making the base material 1 in band form slide inside a tubular body (not illustrated) in which the aforementioned airflow is blown to dry the base material 1 itself. Advantageously, the base material 1 in band form is transported longitudinally inside the tubular body by the same airflow. This makes it possible to dry the base material 1 without the need to hang the latter to hold it with mechanical transportation means, therefore ensuring that the wrinkles formed on the base material 1 during the previous compression and spreading out steps are maintained during the drying step.

Advantageously, the drying step foresees a step of beating the base material 1 in band form against at least one abutment body (not illustrated), in which the base material 1 is thrusted many times by the airflow against such an abutment body, for example consisting of a metal grating, in order to reinforce the wrinkles already created or to create others once again and thus increase the creasing effect.

In greater detail, the drying and beating steps are carried out in a drying machine (not illustrated), which comprises an inlet chamber, in which the base material 1 to be dried is inserted, an outlet chamber, from which the dried base material 1 is preferably taken out, and the aforementioned tubular body, which is arranged between the inlet chamber and the outlet chamber and is connected to them through a first and a second open end thereof, respectively. Moreover, such a drying machine preferably comprises two abutment bodies, a first abutment body of which is fixed in the inlet chamber opposite the first open end of the tubular body and distanced from it, and a second abutment body is fixed in the outlet chamber opposite the second open end of the tubular body and distanced from it. There are also means for supplying air to generate the airflow suitable for drying and moving the base material.

The drying step foresees transporting the base material 1 in band form between the inlet chamber and the outlet chamber making it pass through the tubular body. The transportation of the base material 1 is obtained through airflows generated by the air supply means, as specified hereafter, freely without holding it laterally with holding means.

In greater detail, the drying step foresees, after having inserted the base material 1 in the inlet chamber of the drying machine, generating a first airflow that runs through the inlet chamber and crosses the tubular body until it reaches the outlet chamber picking up the base material 1 with it, taking it through the tubular body until it is discharged into the outlet chamber against the second abutment body, causing a first beating thereof.

The drying step foresees generating a second airflow, in the opposite direction to the first, which transports the base material 1 from the outlet chamber to the inlet chamber making it cross the tubular body and thus pushing the base material 1 against the first abutment body, causing a second beating thereof.

The first and the second airflow are generated in succession by the air supply means until the base material 1 is completely dry. Thereafter, the base material 1 is removed from the drying machine, preferably from the outlet chamber thereof.

The process for producing a material similar to leather also preferably foresees a step of softening the base material 1, in which the latter is treated for example with waxes, vegetable fats, siliconic substances, etc. Such a softening step is foreseen after the compression and spreading out steps have been carried out cyclically, and preferably also after the drying step.

Advantageously, the process for producing a material similar to leather object of the present invention makes it possible to carry out the operative steps described above using the base material 1 in band form with a great length (for example 200 m), in particular without the need to cut the latter into sheets. This makes it possible to produce large amounts of material similar to leather without the need to interrupt the production cycle to swap the treated sheets for those to be treated, in this way obtaining particularly short production times.

The process thus conceived therefore achieves the preset purposes.

Of course it can, in its practical embodiment, also take up different shapes and configurations to the one illustrated above, without for this reason departing from the present scope of protection.

Moreover, all of the details can be replaced with technically equivalent elements and the sizes, the shapes and the materials used can be whatever according to the needs.

1. Process for producing a material similar to leather, which foresees:
a step of providing a base material (1) in band form and comprising a cellulose fibre impregnated with a copolymer dispersion;
a step of impregnating said base material (1) in band form with at least one liquid product;
characterised in that it also foresees:
a step of compressing said base material (1) in band form in at least one duct (2), wherein said base material (1) in band form is compressed transversally in the direction of its own width sliding in at least one compression portion of said duct (2) having a smaller width than the width of said base material (1);
a step of spreading out said base material (1) in band form, wherein the latter opens out at least partially along its own width outside of said at least one compression portion of said duct (2);
said compression step and said spreading out step being repeated cyclically;
and characterised in that said impregnation step foresees impregnating said base material (1) in band form with a liquid treatment product, which flows inside said duct (2) during at least said compression step of said base material (1).

2. Process for producing a material similar to leather according to claim 1, characterised in that said impregnation step, prior to said compression step, foresees dipping said base material (1) in band form in a liquid soaking product contained in a first tank.

3. Process for producing a material similar to leather according to claim 1, characterised in that said spreading out step foresees introducing said base material (1) in band form into a second tank (8) containing said liquid treatment product, connected to said duct (2) and of a greater width than the width of the compression portion of said duct (2).

4. Process for producing a material similar to leather according to claim 1, characterised in that it foresees a dyeing step of said base material (1) with at least one dye dissolved in said liquid treatment product that flows in said duct (2) and in said second tank (8).

5. Process for producing a material similar to leather according to claim 1, characterised in that it foresees a drying step of said base material (1) in band form by blowing at least one airflow against said base material (1).

6. Process for producing a material similar to leather according to claim 5, characterised in that said drying step foresees the transportation of said base material (1) in band form freely through said at least one airflow.

7. Process for producing a material similar to leather according to claim 6, characterised in that said drying step foresees a step of beating said base material (1) in band form against at least one abutment body, against which it is thrusted many times by said at least one airflow.

8. Process for producing a material similar to leather according to claim 1, characterised in that said liquid treatment product is brought, during said compression and spreading out steps, to a temperature substantially between 40° C. and 120° C.

9. Process for producing a material similar to leather according to claim 1, characterised in that said compression and spreading out steps are carried out cyclically for a time period lasting at least one hour.

10. Process for producing a material similar to leather according to claim 1, characterised in that in said impregnation step said liquid treatment product, which wets said base material (1), gives freedom of movement to said cellulose fibres impregnated with said copolymer; said compression step determining the formation on said base material (1) of a plurality of wrinkles, which are stably fixed through permanent deformation of said copolymer.
